(19) United States
(12) Patent Application Publication
(10) Pub. No.: US 2015/0055564 A1
(43) Pub. Date: Feb. 26, 2015

(54) METHODS AND APPARATUS FOR CONFIGURATION OF A VEHICLE-BASED WIRELESS SIGNAL TRANSMISSION RANGE

(71) Applicant: GM GLOBAL TECHNOLOGY OPERATIONS LLC, Detroit, MI (US)

(72) Inventors: MUHAMMAD F. ALAM, MACOMB, MI (US); ABUZAFOR M. RASAL, HAMTRAMCK, MI (US)

(73) Assignee: GM GLOBAL TECHNOLOGY OPERATIONS LLC, Detroit, MI (US)

(21) Appl. No.: 13/971,694

(22) Filed: Aug. 20, 2013

(51) Int. Cl. H04W 52/22; H04W 84/12

(52) U.S. Cl. CPC H04W 52/22; H04W 84/12
USPC 370/329

(57) ABSTRACT

A method of configuring a vehicle-generated wireless connectivity hotspot is provided. The method adjusts a variable power setting for a vehicle onboard wireless transmitter, the vehicle onboard wireless transmitter generating the wireless connectivity hotspot; wherein the wireless connectivity hotspot comprises a variable transmission range, and wherein the variable transmission range is based on the variable power setting.

### TECHNICAL FIELD

Embodiments of the subject matter described herein relate generally to the generation of a wireless signal from a vehicle-based telematics module. More particularly, embodiments of the subject matter relate to the dynamic and/or manual configuration of a range of a wireless signal.

### BACKGROUND

Many vehicles have onboard computer systems offering in-vehicle wireless internet connectivity. Such onboard computer systems will include a wireless transmitter, which creates a wireless local area network (WLAN), and wireless devices within a wireless signal transmission range. A power setting of the wireless transmitter determines the power (and consequently, the transmission range) of the signal from the wireless transmitter in a proportional relationship. In other words, as the power setting of the wireless transmitter is increased, the wireless signal transmission range also increases.

Currently, the industry has established a default power setting of an in-vehicle wireless transmitter at the highest transmit power permitted in a regulatory domain. This default maximum power setting generates a WLAN with a signal transmission range that may be unnecessarily large in some situations, and expends more power than may be necessary to accommodate wireless connectivity needs inside a vehicle.

Accordingly, it is desirable to reduce the signal transmission from a vehicle-based wireless network under certain conditions, thereby reducing the amount of power necessary to operate the wireless transmitter. Furthermore, other desirable features and characteristics will become apparent from the subsequent detailed description and the appended claims, taken in conjunction with the accompanying drawings and the foregoing technical field and background.

### BRIEF SUMMARY

Some embodiments provide a method of configuring a vehicle-generated wireless connectivity hotspot. The method adjusts a variable power setting for a vehicle onboard wireless transmitter, the vehicle onboard wireless transmitter generating the wireless connectivity hotspot; wherein the wireless connectivity hotspot comprises a variable transmission range, and wherein the variable transmission range is based on the variable power setting.

Some embodiments provide an onboard wireless communication system for a vehicle. The onboard wireless communication system includes a wireless transmitter, configured to generate a wireless signal; and a power regulation module, configured to adjust a variable power setting of the wireless transmitter, the variable power setting determining a variable wireless range of the wireless signal.

Some embodiments provide a method for modifying a wireless signal transmission range of a vehicle-based wireless local area network (WLAN). The method detects, at an onboard vehicle system, a vehicle condition that is indicative of a smaller wireless transmission range; and in response to the detected vehicle condition, automatically decreases the wireless signal transmission range.

This summary is provided to introduce a selection of concepts in a simplified form that are further described below in the detailed description. This summary is not intended to identify key features or essential features of the claimed subject matter, nor is it intended to be used as an aid in determining the scope of the claimed subject matter.

### BRIEF DESCRIPTION OF THE DRAWINGS

A more complete understanding of the subject matter may be derived by referring to the detailed description and claims when considered in conjunction with the following figures, wherein like reference numbers refer to similar elements throughout the figures.

FIG. 1 is a functional block diagram of a vehicle that includes an onboard computer system, according to some embodiments;

FIG. 2 is a system diagram of potential transmission ranges of a vehicle-produced wireless network, according to some embodiments;

FIG. 3 is a flow chart illustrating a method of configuring a vehicle-generated wireless connectivity hotspot, according to some embodiments;

FIG. 4 is a flow chart illustrating a method of adjusting a variable wireless transmission range for a vehicle onboard wireless transmitter based on vehicle motion, according to some embodiments;

FIG. 5 is a flow chart illustrating a method of adjusting a variable wireless transmission range for a vehicle onboard wireless transmitter based on a detected level of radio frequency (RF) interference, according to some embodiments;

FIG. 6 is a flow chart illustrating a method of adjusting a variable wireless transmission range for a vehicle onboard wireless transmitter based on the presence of wireless devices within signal transmission range, according to some embodiments; and

FIG. 7 is a flow chart illustrating a method of adjusting a wireless transmission range for a vehicle onboard wireless transmitter when traveling in a group of vehicles, according to some embodiments.

### DETAILED DESCRIPTION

The following detailed description is merely illustrative in nature and is not intended to limit the embodiments of the subject matter or the application and uses of such embodiments. As used herein, the word “exemplary” means “serving as an example, instance, or illustration.” Any implementation described herein as exemplary is not necessarily to be construed as preferred or advantageous over other implementations. Furthermore, there is no intention to be bound by any expressed or implied theory presented in the preceding technical field, background, brief summary or the following detailed description.

The subject matter presented herein relates to methods used to regulate the wireless signal transmission range of a vehicle-generated wireless connectivity hotspot. In some embodiments, a variable power setting of a vehicle onboard wireless transmitter is adjusted to increase or decrease a variable wireless transmission range based on movement of the vehicle, the presence of wireless signal interference, the presence of wireless devices, and/or the sharing of wireless connectivity among vehicles traveling in a group.

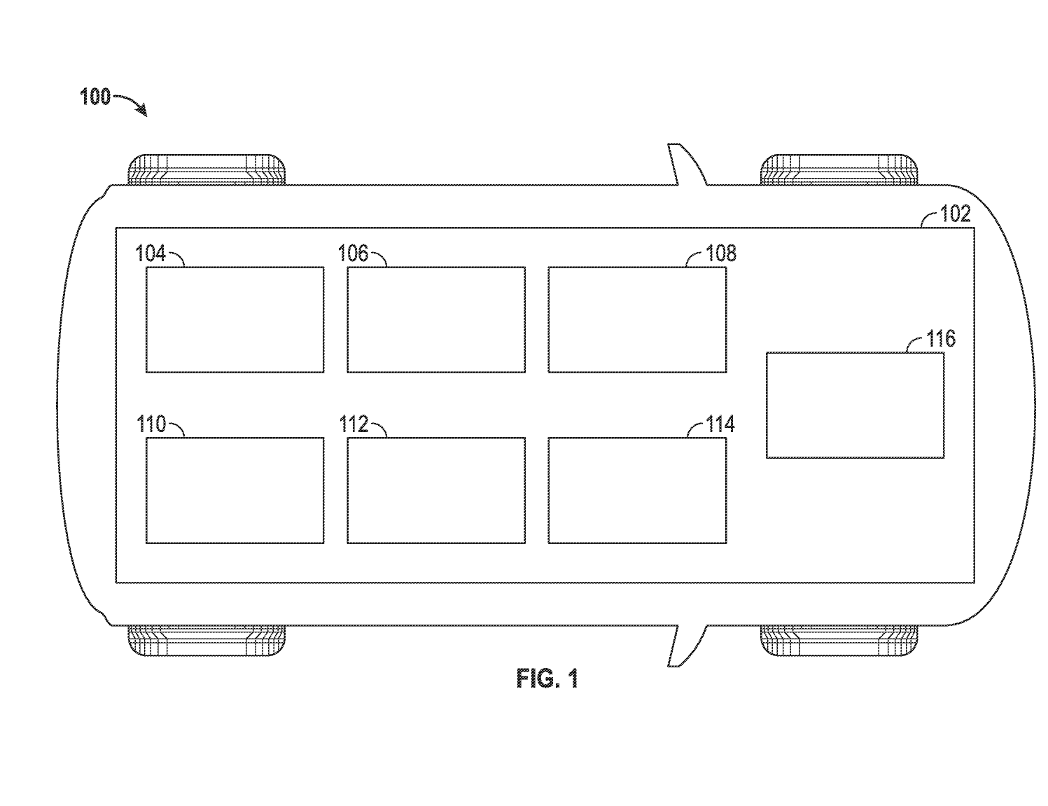

Referring now to the drawings, FIG. 1 is a functional block diagram of a vehicle 100 that includes an onboard computer system 102, according to some embodiments. The onboard computer system 102 may be implemented using any number (including only one) of electronic control modules onboard the vehicle 100. The vehicle 100 may be any one of a number of different types of types of automobiles (sedans, wagons, trucks, motorcycles, sport-utility vehicles, vans, etc.), aviation vehicles (such as airplanes, helicopters, etc.), watercraft (boats, ships, jet skis, etc.), trains, all-terrain vehicles (snowmobiles, four-wheelers, etc.), military vehicles (Humvees, tanks, trucks, etc.), rescue vehicles (fire engines, ladder trucks, police cars, emergency medical services trucks and ambulances, etc.), spacecraft, hovercraft, and the like.

The onboard computer system 102 is configured to transmit wireless signals to support a wireless local area network (WLAN) and to adjust the transmission range based upon detected factors. The onboard computer system 102 may include, without limitation: a processor architecture 104, a system memory 106, a user interface 108, a vehicle data collection module 110, a network interface module 112, a local wireless communication module 114, and a power regulation module 116. These elements and features of an onboard computer system 102 may be operatively associated with one another, coupled to one another, or otherwise configured to cooperate with one another as needed to support the desired functionality—in particular, controlling the wireless signal transmission range of a signal generated at the vehicle 100, as described herein. For ease of illustration and clarity, the various physical, electrical, and logical couplings and interconnections for these elements and features are not depicted in FIG. 1. Moreover, it should be appreciated that embodiments of the onboard computer system 102 will include other elements, modules, and features that cooperate to support the desired functionality. For simplicity, FIG. 1 only depicts certain elements that relate to the wireless signal regulation techniques described in more detail below.

The processor architecture 104 may be implemented or performed with one or more general purpose processors, a content addressable memory, a digital signal processor, an application specific integrated circuit, a field programmable gate array, any suitable programmable logic device, discrete gate or transistor logic, discrete hardware components, or any combination designed to perform the functions described here. In particular, the processor architecture 104 may be realized as one or more microprocessors, controllers, microcontrollers, or state machines. Moreover, the processor architecture 104 may be implemented as a combination of computing devices, e.g., a combination of digital signal processors and microprocessors, a plurality of microprocessors, one or more microprocessors in conjunction with a digital signal processor core, or any other such configuration.

The system memory 106 may be realized using any number of devices, components, or modules, as appropriate to the embodiment. Moreover, the vehicle onboard computer system 102 could include system memory 106 integrated therein and/or system memory 106 operatively coupled thereto, as appropriate to the particular embodiment. In practice, the system memory 106 could be realized as RAM memory, flash memory, EPROM memory, EEPROM memory, registers, a hard disk, a removable disk, or any other form of storage medium known in the art. In certain embodiments, the system memory 106 includes a hard disk, which may also be used to support functions of the onboard computer system 102. The system memory 106 can be coupled to the processor architecture 104 such that the processor architecture 104 can read information from, and write information to, the system memory 106. In the alternative, the system memory 106 may be integral to the processor architecture 104. As an example, the processor architecture 104 and the system memory 106 may reside in a suitably designed application-specific integrated circuit (ASIC).

The user interface 108 may include or cooperate with various features to allow a user to interact with the onboard computer system 102. Accordingly, the user interface 108 may include various human-to-machine interfaces, e.g., a keypad, keys, a keyboard, buttons, switches, knobs, a touchpad, a joystick, a pointing device, a virtual writing tablet, a touch screen, a microphone, or any device, component, or function that enables the user to select options, input information, or otherwise control the operation of the onboard computer system 102. For example, the user interface 108 could be manipulated by an operator to manually configure a power setting and/or wireless transmission range for an onboard computer system 102, as described below.

The vehicle data collection module 110 is suitably configured to collect and provide vehicle data to the onboard computer system 102. Vehicle data may be obtained or generated by any number of onboard sensors, instruments, or devices, as is well understood. Vehicle data may include a selection of factors affecting a variable wireless transmission range of the vehicle 100, including, without limitation: a vehicle speed, a level of radiofrequency interference external to the vehicle, a number of wireless devices within a wireless range of an in-vehicle wireless network, and the like. The vehicle data collection module 110 communicates with elements of the onboard computer system 102 to obtain and communicate requested information during configuration and/or adjustment of a vehicle-generated local wireless network.

The network interface module 112 is suitably configured to communicate data between the onboard computer system 102 and one or more remote servers. In certain embodiments, the network interface module 112 is implemented as an onboard vehicle communication or telematics system, such as an OnStar® module commercially marketed and sold by the OnStar® corporation, which is a subsidiary of the assignee of the instant Application, the General Motors Company, currently headquartered in Detroit, Mich. In embodiments wherein the network interface module 112 is an OnStar® module, an internal transceiver may be capable of providing bi-directional mobile phone voice and data communication, implemented as Code Division Multiple Access (CDMA). In some embodiments, other 3G technologies may be used to implement the network interface module 112, including without limitation: Universal Mobile Telecommunications System (UMTS) wideband CDMA (W-CDMA), Enhanced Data Rates for GSM Evolution (EDGE), Evolved EDGE, High Speed Packet Access (HSPA), CDMA2000, and the like. In some embodiments, 4G technologies may be used to implement the network interface module 112, alone or in combination with 3G technologies, including without limitation: Evolved High Speed Packet Access (HSPA+), Long Term Evolution (LTE) and/or Long Term Evolution-Advanced (LTE-A). As described in more detail below, data received by the network interface module 112 may include, without limitation: downloadable software applications, GPS location data, various forms of media (e.g., music, video, picture data, etc.), and other data compatible with the onboard computer system 102. Data provided by the network interface module 112 may include, without limitation, requests to download software applications, and the like.

The local wireless communication module 114 is suitably configured to provide a local wireless network for the transmission of signals between one or more devices within a wireless transmission range of the onboard computer system 102. For example, the local wireless communication module 114 generates a local wireless communication network that is used to communicate data between the onboard computer system 102 and any connected peripheral wireless devices. In some embodiments, the local wireless communication module 114 generates a WLAN network that is compatible with an IEEE 802.11 standard, and in other embodiments, the local wireless communication module 114 may generate an ad-hoc network, a Bluetooth network, a personal area network (PAN), or the like.

The communication range of the local wireless network generated by the local wireless communication module 114 may be increased and/or decreased to accommodate various driving conditions or conditions of the vehicle 100 itself. The wireless signal transmission range is determined considering such factors as the size of the vehicle, the necessary signal transmission range to cover the vehicle itself, the potential for interference, the position of the wireless transmitter on the vehicle, etc. By default, the vehicle 100 transmits a wireless signal having a maximum transmission range permitted by current law, which utilizes the maximum possible transmit power. However, when traveling, it is often not necessary for a vehicle-based wireless network to provide the maximum amount of coverage area. Generally, vehicle-based wireless networks are used to accommodate vehicle 100 passengers, and the maximum wireless signal transmission range provides a coverage area that is much larger than the vehicle 100 itself In these circumstances, a decrease in the signal transmission range is beneficial, to save power and to promote security of the vehicle-based wireless network. When a vehicle 100 is stationary, users that choose to exit the vehicle 100 may prefer a larger wireless signal transmission range, to accommodate continued use of wireless devices while outside the vehicle. When there is significant wireless signal transmission from wireless networks that are external to the vehicle, users may prefer an increase in signal transmission strength to prevent interference in the vehicle-based wireless network. When there are no peripheral wireless devices connected to the in-vehicle wireless network, the wireless signal transmission range may be decreased (or eliminated altogether) to save power. When the vehicle 100 is traveling with a group of vehicles that wish to share wireless connectivity, the wireless signal transmission range may be increased and/or maximized to accommodate a larger coverage area. In addition, when a Bluetooth feature of the vehicle is active, allowing an occupant of the vehicle to conduct a cellular telephone call, an increased level of wireless communication interference may be present. In this example, it would be beneficial to increase the communication range of the wireless communication module 114, to provide a stronger wireless communication signal. Also, when the local wireless communication module 114 detects corrupted communication packets, the wireless communication range may be increased to address this problem. When the number of corrupted communication packets decreases, the wireless communication range may also be decreased.

The transmission range is adjusted by the power regulation module 116, described below. In certain embodiments, the local wireless communication module 114 may be configured to use a high-power transmission setting, achieving a maximum signal transmission range for the local wireless network. In other embodiments, the local wireless communication module 114 may be configured to use a low-power transmission setting, achieving a smaller transmission range for the local wireless network. The amount of power used in a low-power setting, and consequently, the dimensions of the smaller transmission range, are design choices determined in production of the vehicle.

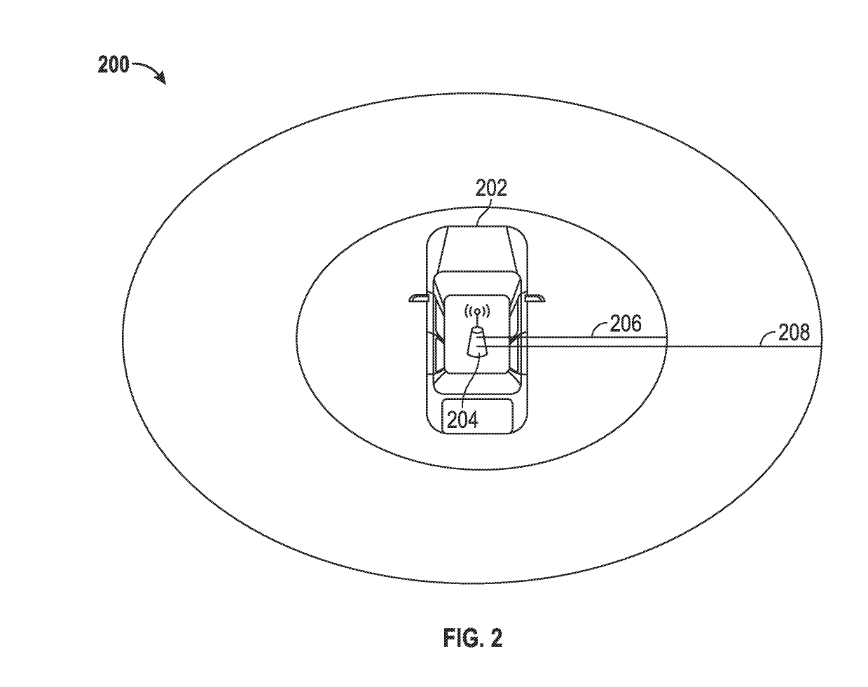

FIG. 2 is a system diagram of potential transmission ranges of a vehicle-generated wireless network 200, utilizing a high-power setting and a low-power setting. As shown, a vehicle 202 utilizes a wireless transmitter 204 to generate a wireless network 200, which may be adjusted from a high-power transmission range 208 to a low-power transmission range 206. The high-power transmission range 208 reflects a default power setting for the wireless transmitter 204. This power setting may be adjusted (e.g., decreased) to create the low-power transmission range 206 by reducing the transmit power level, when user-configured conditions have been met.

In some embodiments, the signal transmission range may include other options in addition to a high-power setting and a low-power setting. For example, a custom transmission range may be used to accommodate pre-determined conditions of the vehicle, such as: vehicle in motion, vehicle is stationary, vehicle is traveling in a group of other vehicles, vehicle is traveling singly, vehicle detects wireless interference, vehicle detects no wireless interference, vehicle detects connected wireless devices inside the vehicle, vehicle detects no connected wireless devices inside the vehicle, and the like. As another example, more than two discrete power levels could be supported. In alternative implementations, the power level could be continuously adjustable with no predetermined discrete levels. In accordance with certain embodiments, custom signal transmission ranges are determined at production of the vehicle.

Generally, the network interface module 112 communicates using different protocols than that of the local wireless communication module 114. In this regard, the communication network utilized by the network interface module 112 may be physically and/or logically distinct from the network created by the local wireless communication module 114 to establish the communication between devices onboard a vehicle 100. For example, the local wireless communication module 114 creates a first network that may be realized as a wireless local area network (WLAN), while the network interface module 112 utilizes a network that is realized as the Internet, a cellular network, a broadband network, a wide area network, or the like.

The power regulation module 116 is suitably configured to regulate a power setting of the local wireless communication module 114. Regulating the power setting effectively adjusts the transmission range of the local wireless network created by the local wireless communication module 114. The power setting may be defined as the amount of power used by the local wireless communication module 114 in generating a wireless communication signal for transmission. For example, increasing the power setting increases the transmission range of the local wireless network, and decreasing the power setting decreases the transmission range.

The power setting of the local wireless communication module 114 may be set manually or automatically. A user may manually adjust the power setting via (i) the user interface 108 of the onboard computer system 102; (ii) the network interface module 112 in communication with a remote server; or (iii) an electronic device wirelessly communicating with the onboard computer system 102.

The user interface 108 of the onboard computer system 102 may be used to adjust the power setting of the local wireless communication module 114. Through the user interface 108, a user may access screens detailing user-configurable settings of the local wireless communication module 114, including a power setting for the local wireless communication module 114. The user interface 108 screens may provide user selectable options, fields for entering user selected data, and the like.

The network interface module 112 may also be used in the user configuration of the power setting of the local wireless communication module 114. The network interface module 112 has the capability to send a request to a remote server, and in response to the request, the remote server sends a command to alter the power setting of the local wireless communication module 114. In some embodiments, both the local wireless communication module 114 and the network interface module 112 are integrally implemented as an OnStar® module. In this example, the request is sent to a remotely-located, vehicle telematics service (e.g., OnStar®), which has the capability of adjusting the power setting remotely and communicating that adjustment using a cellular link to the OnStar® module.

An electronic device with the capability of communicating wirelessly with the onboard computer system 102 may also be used to configure the power setting of the local wireless communication module 114. In certain embodiments, the electronic device may be a portable wireless communication device or smartphone having the capabilities of connecting to the Internet, downloading software applications (“apps”), and providing a user with access to a variety of additional applications and services. In some embodiments, the electronic device may include an app specifically designed for communication with the onboard computer system 102 and configuring the power setting of the local wireless communication module 114 through such communication.

The power setting of the local wireless communication module 114 may be automatically and dynamically adjusted by the power regulation module 116 according to user-specified parameters. Generally, these user-specified parameters indicate when a larger or smaller wireless signal transmission range is needed, for which the power setting must be adjusted. Possible user-specified factors that may determine automatic adjustment of the power setting may include, without limitation: whether the vehicle 100 is in motion or stationary, a level of interference from wireless networks external to the vehicle 100, the number of devices connected to the local wireless network of the vehicle 100, and/or whether the vehicle 100 is traveling in a group of vehicles approved for sharing wireless connectivity.

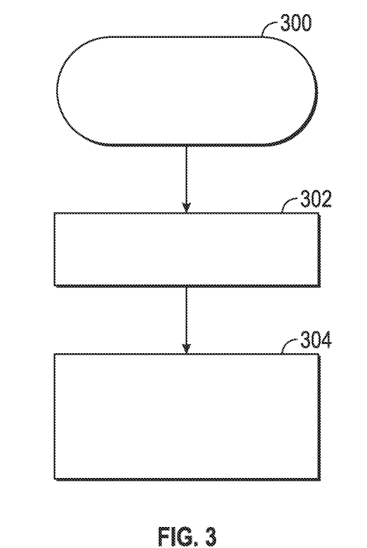

FIG. 3 is a flow chart illustrating an embodiment of a process 300 of configuring a vehicle-generated wireless connectivity hotspot. The various tasks performed in connection with process 300 described here may be performed by software, hardware, firmware, or any combination thereof. For illustrative purposes, the description of process 300 may refer to elements mentioned above in connection with FIGS. 1-2. In practice, portions of a described process may be performed by different elements of the described system, e.g., the system firmware, logic within a vehicle onboard computer system, or other logic in the system. It should be appreciated that a described process may include any number of additional or alternative tasks, the tasks shown in the figures need not be performed in the illustrated order, and that a described process may be incorporated into a more comprehensive procedure or process having additional functionality not described in detail herein. Moreover, one or more of the tasks shown in the figures could be omitted from embodiments of a described process as long as the intended overall functionality remains intact.

For ease of description and clarity, this example assumes that the process 300 begins by detecting applicable wireless transmission factors of the vehicle, as described with respect to FIG. 1, (step 302) which may include: whether the vehicle is in motion or stationary, a level of interference from wireless networks external to the vehicle, the number of devices connected to the local wireless network of the vehicle, and/or whether the vehicle is traveling in a group of vehicles approved for sharing wireless connectivity.

Once the applicable wireless transmission factors have been detected (step 302), the process 300 will analyze the factors to determine whether or not, and how to adjust a wireless communication range of the vehicle. Next, the process 300 initiates the adjustment of a variable power setting for a vehicle onboard wireless transmitter based on the detected wireless transmission factors (step 304). Adjustment of this power setting (i.e., the transmit power of the wireless transmitter) increases or decreases a wireless signal transmission range, which effectively increases or decreases the area of the wireless connectivity hotspot created by the vehicle. This description contemplates the use of different types of criteria that governs whether or not the power level is increased or decreased. A number of exemplary implementations are presented in more detail below.

### Adjusting Wireless Transmission Range Based on Vehicle Motion

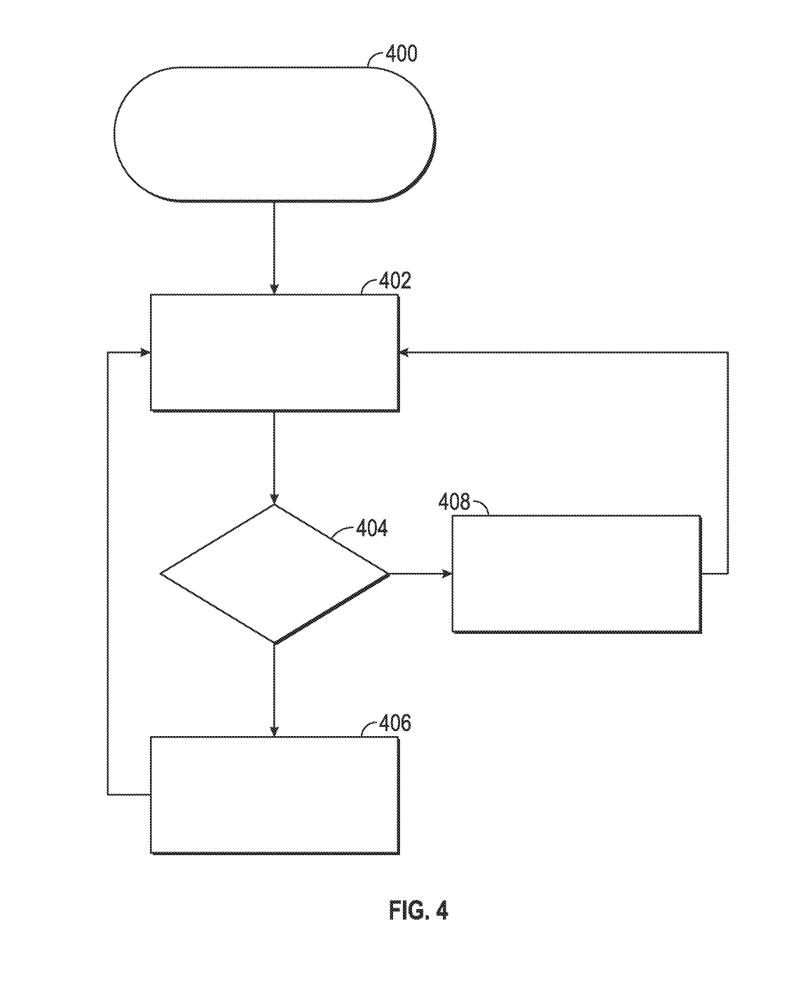

FIG. 4 is a flow chart illustrating an embodiment of a process 400 of adjusting a variable wireless transmission range for a vehicle onboard wireless transmitter, based on vehicle motion. This example illustrates the use of a low-power setting for the wireless transmitter when the vehicle is in motion, and the use of a high-power setting for the wireless transmitter when the vehicle is not in motion. In certain embodiments, a vehicle onboard computer system automatically adjusts the power setting, and in other embodiments, a user is prompted to adjust the power setting when the detected vehicle speed is above or below a vehicle speed threshold.

For ease of description and clarity, this example assumes that the process 400 begins by detecting a current vehicle speed (step 402). As described with respect to FIG. 1, vehicle speed information is obtained by an onboard computer system from a vehicle sensor, such as a speedometer. If the detected vehicle speed is greater than or equal to a predetermined threshold (the “Yes” branch of 404), the process 400 will use the low-power setting of the wireless transmitter for the vehicle-based wireless network (step 406).

The predetermined threshold is a vehicle speed value that indicates a numerical separation between a vehicle in motion and a stationary vehicle. Vehicle speed values greater than or equal to the predetermined threshold indicate that the vehicle is traveling, while values below the predetermined threshold indicate that the vehicle is not traveling. The predetermined threshold may be a default value that is programmed into the system at design time, or the predetermined threshold may be determined and configured by a user, using an onboard vehicle computer system.

In certain embodiments, a vehicle onboard wireless transmitter may utilize varying power settings, such as a high-power or low-power setting. Each power setting has a directly proportional relationship with a corresponding transmission range. For example, an increased power setting (i.e., a high-power setting) of the wireless transmitter generates an increased wireless transmission range, which produces a larger wireless connectivity hotspot. Similarly, a decreased power setting (i.e., a low-power setting) of the wireless transmitter generates a decreased wireless transmission range, producing a smaller wireless connectivity hotspot.

Here, using the low-power setting of the wireless transmitter for the vehicle-based wireless network (step 406) causes the wireless transmitter to generate a smaller wireless signal transmission range. In this case, because the vehicle is traveling, a wireless signal transmission range extending far beyond the vehicle itself is unnecessary. A wireless signal transmission range large enough for the passengers inside the vehicle is sufficient, because there are no users outside the vehicle.

However, if the detected vehicle speed is not greater than or equal to the predetermined threshold (the “No” branch of 408), the process 400 will continue to use the high-power setting of the wireless transmitter for the vehicle-based wireless network (step 408), generating the maximum wireless signal transmission range. Here, the vehicle is not traveling, and users of the vehicle-generated wireless network may be located inside or outside the vehicle. In this example, a larger signal transmission range accommodates the possibility of users outside the vehicle.

### Adjusting Wireless Transmission Range Based on RF Interference

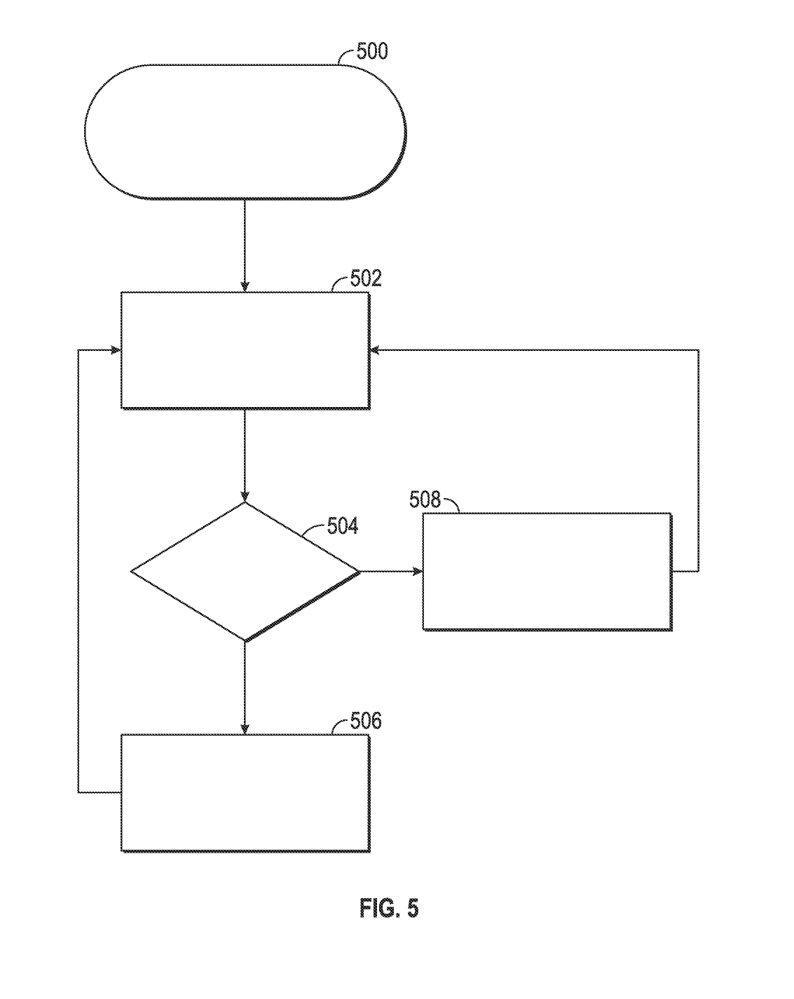

FIG. 5 is a flow chart illustrating an embodiment of a process 500 of configuring a vehicle-generated wireless connectivity hotspot based on a detected level of radio frequency (RF) interference. This example illustrates the use of a high-power setting for the wireless transmitter when the vehicle detects the presence of a high level of RF interference, and the use of a low-power setting for the wireless transmitter when the vehicle detects a low or non-existent level of RF interference.

This example assumes that the process 500 begins by detecting a current level of RF interference (step 502). In certain embodiments, the current level of RF interference may be detected by a determination of the presence of wireless hotspots that are external to the vehicle. In some embodiments, a number of devices with a wireless communication connection to a vehicle telematics module are detected. The greater the number of connected devices, the greater the level of RF interference. Additionally, each connected device has a signal strength, detected using a received signal strength indication (RSSI). In scenarios where a plurality of connected devices are showing low RSSI values, a high level of RF interference is indicated.

After detecting the current level of RF interference (step 502), the process 500 determines whether the detected level of RF interference is less than a predetermined threshold (step 504). The predetermined threshold is a level of RF interference that is tolerable by the vehicle generated wireless network, without interfering with wireless connectivity of wireless devices inside the vehicle. Levels of RF interference greater than or equal to the predetermined threshold indicate a weak vehicle generated wireless network signal, which may be improved with an increase in the transmit power. Levels of RF interference less than the predetermined threshold indicate a vehicle generated wireless network signal that is strong enough to provide users network access without connectivity issues, or in other words, if the detected level of RF interference is not high enough to cause disruption in the vehicle-based wireless network. As with the vehicle speed, the predetermined threshold for the level of RF interference may be a default value that is programmed into the system at design time, or the predetermined threshold may be determined and configured by a user, using an onboard vehicle computer system.

If the detected level of RF interference is less than the predetermined threshold (the “Yes” branch of 504), the process 500 will use the low-power setting of the wireless transmitter for the vehicle-based wireless network (step 510). As described above with regard to FIG. 4, each power setting has a directly proportional relationship with a corresponding transmission range.

Here, using the low-power setting of the wireless transmitter for the vehicle-based wireless network (step 506) causes the wireless transmitter to generate a smaller wireless signal transmission range. However, if the detected level of RF interference is not less than the predetermined threshold (the “No” branch of 504), the process 500 will use the high-power setting of the wireless transmitter for the vehicle-based wireless network (step 508), generating the maximum wireless signal transmission range.

### Adjusting Wireless Transmission Range Based on Detected Wireless Devices

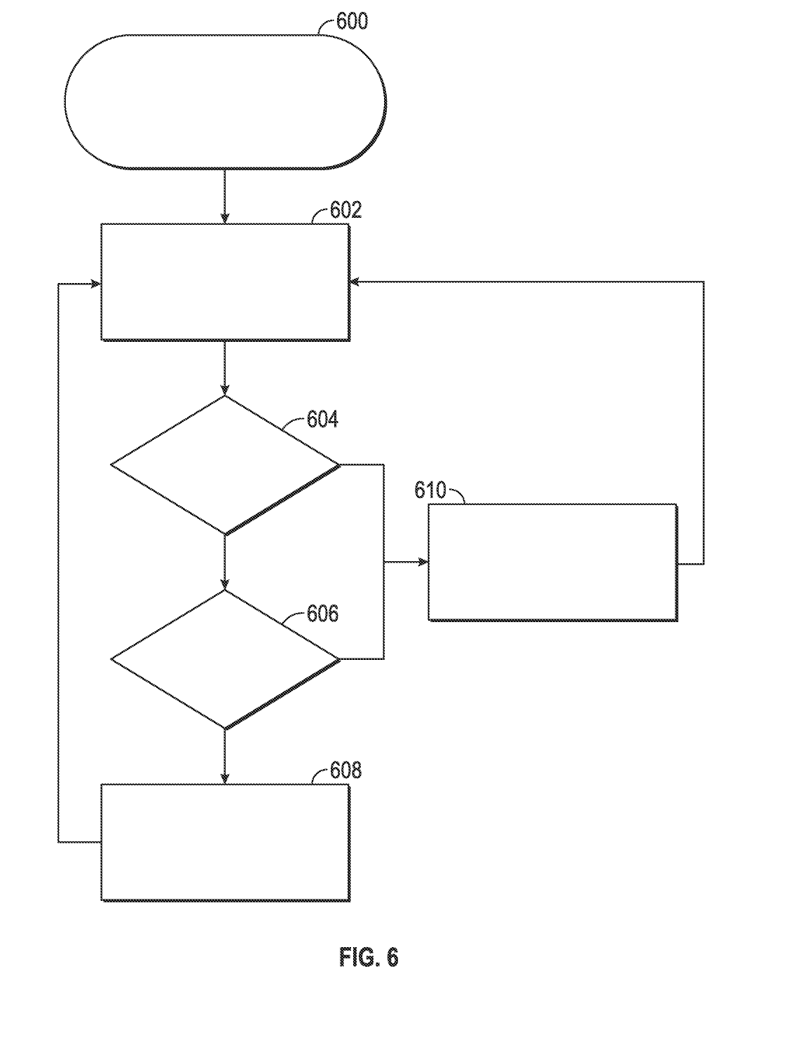

FIG. 6 is a flow chart illustrating an embodiment of a process 600 of adjusting a vehicle-generated wireless connectivity hotspot based on a number of wireless devices located within a wireless signal transmission range. This example assumes that the process 600 begins by searching for wireless devices within a wireless signal transmission range of a vehicle-generated wireless network (step 602). Searching for devices with wireless communication capability may be performed by a vehicle onboard computer system, vehicle-based telematics module, or any vehicle-based device configured to detect and communicate the presence of wireless devices within a defined wireless signal transmission range. A wireless device may be any electronic device that is configured to communicate wirelessly, using the same communication protocol as does the vehicle-based wireless transmitter. Generally, the wireless devices detected will be located inside the vehicle, but in some embodiments, the devices may be located outside of the vehicle but still within transmission range of the vehicle-based wireless signal.

When at least one wireless device is not detected (the “No” branch of 604), the process 600 initiates use of a low-power setting for the wireless transmitter of the vehicle-based wireless network (step 610). As described with regard to FIG. 5, using the low-power setting of the wireless transmitter for the vehicle-based wireless network (step 610) causes the wireless transmitter to generate a wireless signal transmission range that is smaller than the maximum wireless signal transmission range generated using a high-power setting of the wireless transmitter. Once the wireless transmitter goes into a low-power setting (step 610), the process 600 returns to searching for wireless devices within a wireless signal transmission range (step 602) of the vehicle.

When at least one wireless device has been detected (the “Yes” branch of 604), the process 600 determines a signal strength of the wireless device (step 606). Generally, signal strength of a wireless device is determined by the vehicle onboard computer system using received signal strength indication (RSSI) signals from detected wireless devices. If the signal strength of a detected wireless device is less than a predetermined threshold (the “Yes” branch of 606), the process 600 uses a high-power setting of the wireless transmitter for the vehicle-based wireless network (step 608). Here, the predetermined threshold indicates a minimum value of signal strength for a wireless device to connect and communicate effectively, using the vehicle-generated wireless network. When the predetermined threshold is not met, the wireless transmitter increases its transmit power, thereby increasing strength of the connection between the vehicle-generated wireless network and the wireless device.

If the signal strength of the wireless device is not less than a predetermined threshold (the “No” branch of 606), the process 600 uses the low-power setting of the wireless transmitter for the vehicle-based wireless network (step 610). In this case, a signal strength of greater than or equal to the predetermined threshold value indicates that the signal from the wireless device is strong enough to maintain an acceptable connection, as determined by design criteria.

Adjusting Wireless Transmission Range when Traveling in a Group of Vehicles

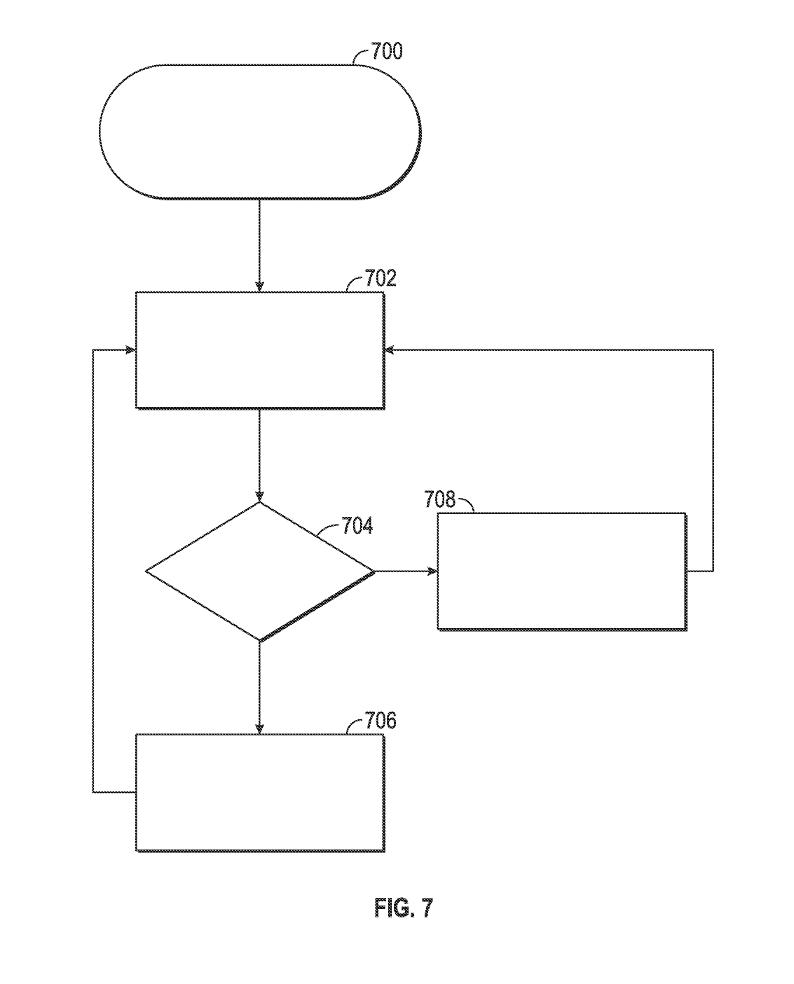

FIG. 7 is a flow chart illustrating an embodiment of a process 700 of adjusting a vehicle-generated wireless connectivity hotspot when traveling in a group of vehicles and providing shared network connectivity. This example illustrates the use of a high-power setting for the wireless transmitter when the vehicle is traveling in a group of vehicles and wishes to share access to the vehicle-generated wireless network. Further, this example details the use of a low-power setting for the wireless transmitter when the vehicle is not traveling in a group of vehicles approved for wireless access-sharing, and the wireless transmitter is providing wireless connectivity within one vehicle only.

This example assumes that the process 700 begins by receiving user input regarding traveling in a group of vehicles (step 502). Here, a user indicates whether or not the vehicle is traveling in a group of vehicles approved to share in the vehicle-generated wireless network. In certain embodiments, the user input is received at a user interface for an onboard computer system of the vehicle. In other embodiments, user input is received at a remote electronics device configured to communicate wirelessly with the onboard computer system, using a specialized software application or otherwise. In some embodiments, user input may be a command received at an in-vehicle telematics module, which then sends a request to a remote server for further action.

If the vehicle is traveling in a group of vehicles approved to share the vehicle-generated wireless network (the “Yes” branch of 704), the process 700 initiates use of the high-power setting of the wireless transmitter for the vehicle-based wireless network (step 706). The high-power setting causes the wireless transmitter to utilize the maximum transmit power for the vehicle-generated wireless signal, increasing the signal transmission range and increasing the wireless hotspot coverage area to its maximum. This maximum area will allow other vehicles, which are traveling within the wireless signal transmission range of the first vehicle, to connect to the vehicle-generated wireless network.

If the vehicle is not traveling in a group of vehicles approved to share the vehicle-generated wireless network (the “No” branch of 704), the process 700 initiates use of the low-power setting of the wireless transmitter for the vehicle-based wireless network (step 708). The low-power setting decreases the transmit power for a vehicle-generated wireless signal, creating a shorter transmission range and a smaller wireless hotspot coverage area. In certain embodiments, use of the low-power setting creates a wireless hotspot that is large enough to include one car only. In other embodiments, use of the low-power setting may create a wireless hotspot that includes the vehicle itself and a specified, small amount of area outside the vehicle. In this example, a user of a wireless device would still enjoy wireless connectivity after exiting the vehicle, if the occupant were to remain within a short wireless range of the vehicle.

In both cases, the process 700 returns to receive user input regarding traveling in a group of vehicles (step 702), and the power setting of the wireless transmitter may be changed at any time, with additional user input.

Techniques and technologies may be described herein in terms of functional and/or logical block components, and with reference to symbolic representations of operations, processing tasks, and functions that may be performed by various computing components or devices. Such operations, tasks, and functions are sometimes referred to as being computer-executed, computerized, software-implemented, or computer-implemented. In practice, one or more processor devices can carry out the described operations, tasks, and functions by manipulating electrical signals representing data bits at memory locations in the system memory, as well as other processing of signals. The memory locations where data bits are maintained are physical locations that have particular electrical, magnetic, optical, or organic properties corresponding to the data bits. It should be appreciated that the various block components shown in the figures may be realized by any number of hardware, software, and/or firmware components configured to perform the specified functions. For example, an embodiment of a system or a component may employ various integrated circuit components, e.g., memory elements, digital signal processing elements, logic elements, look-up tables, or the like, which may carry out a variety of functions under the control of one or more microprocessors or other control devices.

When implemented in software or firmware, various elements of the systems described herein are essentially the code segments or instructions that perform the various tasks. The program or code segments can be stored in a processor-readable medium or transmitted by a computer data signal embodied in a carrier wave over a transmission medium or communication path. The “computer readable medium,” “processor readable medium,” or “machine readable medium” may include any medium that can store or transfer information. Examples of the processor-readable medium include an electronic circuit, a semiconductor memory device, a ROM, a flash memory, an erasable ROM (EROM), a floppy diskette, a CD-ROM, an optical disk, a hard disk, a fiber optic medium, a radio frequency (RF) link, or the like. The computer data signal may include any signal that can propagate over a transmission medium such as electronic network channels, optical fibers, air, electromagnetic paths, or RF links. The code segments may be downloaded via computer networks such as the Internet, an intranet, a LAN, or the like.

While at least one exemplary embodiment has been presented in the foregoing detailed description, it should be appreciated that a vast number of variations exist. It should also be appreciated that the exemplary embodiment or embodiments described herein are not intended to limit the scope, applicability, or configuration of the claimed subject matter in any way. Rather, the foregoing detailed description will provide those skilled in the art with a convenient road map for implementing the described embodiment or embodiments. It should be understood that various changes can be made in the function and arrangement of elements without departing from the scope defined by the claims, which includes known equivalents and foreseeable equivalents at the time of filing this patent application.

What is claimed is:

1. A method of configuring a vehicle-generated wireless connectivity hotspot, the method comprising:
adjusting a variable power setting for a vehicle onboard wireless transmitter, the vehicle onboard wireless transmitter generating the wireless connectivity hotspot;
wherein the wireless connectivity hotspot comprises a variable transmission range, and wherein the variable transmission range is based on the variable power setting.

2. The method of claim 1, further comprising:
detecting a current speed of the vehicle, wherein the adjusting step comprises adjusting the variable power setting in response to the detected current speed of the vehicle.

3. The method of claim 2, further comprising:
in response to the detected current speed of the vehicle , prompting a user to manually adjust the variable power setting of the vehicle onboard wireless transmitter.

4. The method of claim 2, further comprising:
comparing the detected current speed of the vehicle to a threshold; and
when the detected current speed of the vehicle is above the threshold, the adjusting step comprises reducing the variable power setting for the vehicle onboard wireless transmitter.

5. The method of claim 2, further comprising:
comparing the detected current speed of the vehicle to a threshold; and
when the detected current speed of the vehicle is below the threshold, the adjusting step comprises increasing the variable power setting for the vehicle onboard wireless transmitter.

6. The method of claim 1, further comprising:
detecting a signal strength of a wirelessly connected peripheral device, wherein the adjusting step comprises adjusting the variable power setting in response to the detected signal strength of the wirelessly connected peripheral device.

7. The method of claim 1, further comprising:
receiving a variable power setting adjustment command from a user interface of a vehicle onboard computer system;
wherein the step of adjusting the variable power setting is influenced by the received variable power setting adjustment command.

8. The method of claim 1, further comprising:
receiving a variable power setting adjustment command from a remote electronic device;
wherein the step of adjusting the variable power setting is influenced by the received variable power setting adjustment command.

9. The method of claim 1, further comprising:
receiving a user command at a vehicle-based telematics module, the telematics module communicatively coupled to the vehicle onboard wireless transmitter;
sending a remote-based telematics control request in response to the user command; and
after sending the remote-based telematics control request, receiving a second command to adjust the variable power setting for the vehicle onboard wireless transmitter;
wherein the step of adjusting the variable power setting is influenced by the received second command.

10. An onboard wireless communication system for a vehicle, comprising:
a wireless transmitter, configured to generate a wireless signal; and
a power regulation module, configured to adjust a variable power setting of the wireless transmitter, the variable power setting determining a variable wireless range of the wireless signal.

11. The onboard wireless communication system of claim 10, further comprising:
a user interface, communicatively coupled to the power regulation module, the user interface configured to receive manual adjustment commands that control adjustment of the variable power setting of the wireless transmitter.

12. The onboard wireless communication system of claim 10, wherein the power regulation module is further configured to adjust the variable power setting in a manner that is influenced by a detected speed of the vehicle.

13. The onboard wireless communication system of claim 12, wherein the power regulation module is further configured to:
increase the power setting when the detected speed is below a threshold; and
decrease the power setting when the detected speed is above the threshold.

14. The onboard wireless communication system of claim 13, wherein the power regulation module is further configured to receive and process a system override in the form of a manual power adjustment command.

15. The onboard wireless communication system of claim 10, wherein the power regulation module is further configured to:
increase the power setting when a level of wireless signal interference, detected by an onboard system, is above a threshold; and
decrease the power setting when the detected level of wireless signal interference is below the threshold.

16. A method for modifying a wireless signal transmission range of a vehicle-based wireless local area network (WLAN), the method comprising:
detecting, at an onboard vehicle system, a vehicle condition that is indicative of a smaller wireless transmission range; and
in response to the detected vehicle condition, automatically decreasing the wireless signal transmission range.

17. The method of claim 16, wherein the detecting step comprises detecting a vehicle speed above a threshold.

18. The method of claim 16, wherein the detecting step comprises detecting a level of wireless signal interference below a threshold.

19. The method of claim 16, further comprising:
detecting, at a second onboard vehicle system, a second vehicle condition; and
in response to the second vehicle condition, increasing the wireless signal transmission range.

20. The method of claim 19, wherein the detecting, at a second onboard vehicle system, a second vehicle condition comprises detecting a vehicle speed below a threshold.
